(19) United States
(12) Patent Application Publication
(10) Pub. No.: US 2002/0043802 A1
(43) Pub. Date: Apr. 18, 2002

(54) E-Z hose coupling

(76) Inventor: Wallace C. Koster, Chambersburg, PA (US)

Correspondence Address: JAMES W. KOLLAS, 1104 FERNWOOD AVENUE, CAMP HILL, PA, 17011, US

(21) Appl. No.: 09/973,246

(22) Filed: Oct. 9, 2001

Related U.S. Application Data
(60) Provisional application No. 60/239,720, filed on Oct. 12, 2000.

(51) Int. Cl. F16L 33/00

(52) U.S. Cl. 285/242

(57) ABSTRACT

A hose coupling device is connected to a hose to allow the hose to freely rotate around the axis of the hose coupling device and the hose, such that torque, twisting or kinking of the hose is relieved, released, or eliminated. A hose 30 is cut into two portions. Each portion of the hose 30 is fitted with an insert 24, which holds a nut 22 against the lipped side of said insert 24. Hose clamps 26 are placed over each portion of the hose 30, above each insert 24 and against each nut 22. A threaded pipe nipple 20 is fitted into each nut 22. Screws 28 are tightened into hose clamps 26. Torque, twisting or kinking of the hose is relieved, released, or eliminated by allowing the two portions of the hose to rotate relative to each other.

### CROSS REFERENCE TO RELATED APPLICATIONS

This application is entitled to the benefit of Provisional Patent Application Ser. #60/239720 filed Oct. 12, 2000.

### STATEMENT REGARDING FEDERALLY SPONSORED RESEARCH OR DEVELOPMENT

Not applicable.

### BACKGROUND

1. Field of the Invention

This invention is directed toward the field of hoses, more particularly kink-resistant hoses that allow for release of torque via an in-line swivel or rotational device, eliminating the tendency for hoses to twist or kink.

2. Discussion of Prior Art

Commonly, use of a hose in watering (home gardening and lawn maintenance) operations results in twisting or kinking of the hose. By “kinking” it is meant that the wall of the hose is pinched or otherwise closed or restricted such that water flow through the hose is greatly reduced or stopped completely. Kinking normally occurs when a hose is severely bent, doubled over, or similarly twisted. Kinking is a frequent occurrence and is a result of the movement of the hose during the user's travels while holding the hose. Kinking in the hose requires user intervention to unkink the hose manually, thus causing the user delay, inconvenience and annoyance.

The prior art shows use of swivel or rotational devices in gasoline hose applications. These devices are located between the hose and the pumping grip and nozzle, and only eliminate twisting of the hose at or near the point where the user grabs the hose for insertion of the nozzle into a gasoline fuel tank. Additionally, the gasoline hose swivel device is made of metal, makes for cumbersome use of the hose, and is otherwise unfit for use in home gardening and lawn maintenance operations.

The prior art also shows numerous examples of female and male couplings, made of plastic or metal, for mating ends of garden hoses, enabling separate hoses to be linked together into one continuous hose. These couplings fit tightly and provide no rotation around the axis of the hose. Hence, there is no torque, twist, or kink relief associated with their design.

### BRIEF SUMMARY OF THE INVENTION

In accordance with the present invention, a device is connected to a hose to allow the hose to freely rotate around the axis of the device and hose, such that torque, twisting or kinking of the hose is relieved, released, or eliminated.

### OBJECTS AND ADVANTAGES

Accordingly, the objects and advantages of the invention are:

A) to provide a hose coupling device capable of releasing torque, twisting or kinking in a hose.

B) to provide a low cost hose coupling device capable of releasing torque, twisting or kinking in a hose.

C) to provide a hose coupling device capable of being connected along a length of hose at locations found necessary by the user.

D) to provide a hose coupling device which is simple to install.

E) to provide a method for releasing torque, twisting or kinking in a hose.

Further objects and advantages are to provide hose coupling device which will alleviate user annoyance, frustration, and inefficiency associated with torque, twisting or kinking in a hose. Still further objects and advantages will become apparent from consideration of the ensuing description and drawings.

### BRIEF DESCRIPTION OF THE DRAWINGS

FIG. 1 shows a cross-sectional view of the coupling device attached between two lengths of hose.

FIG. 2 is an exploded view of the components of the coupling device.

Reference Numerals in Drawings

20 Threaded pipe nipple

22 Nut

24 Insert

26 Hose clamp

28 Screw

30 Hose

### DETAILED DESCRIPTION OF INVENTION

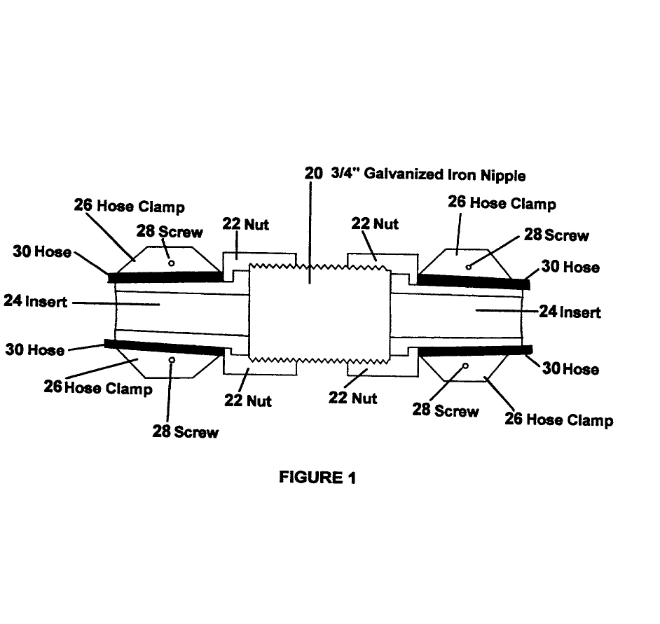

As best illustrated in FIG. 1, the coupling device, or E-Z hose, comprises two inserts 24, two hose clamps 26, a threaded pipe nipple 20, two nuts 22, and four screws 28. A hose 30 is also shown.

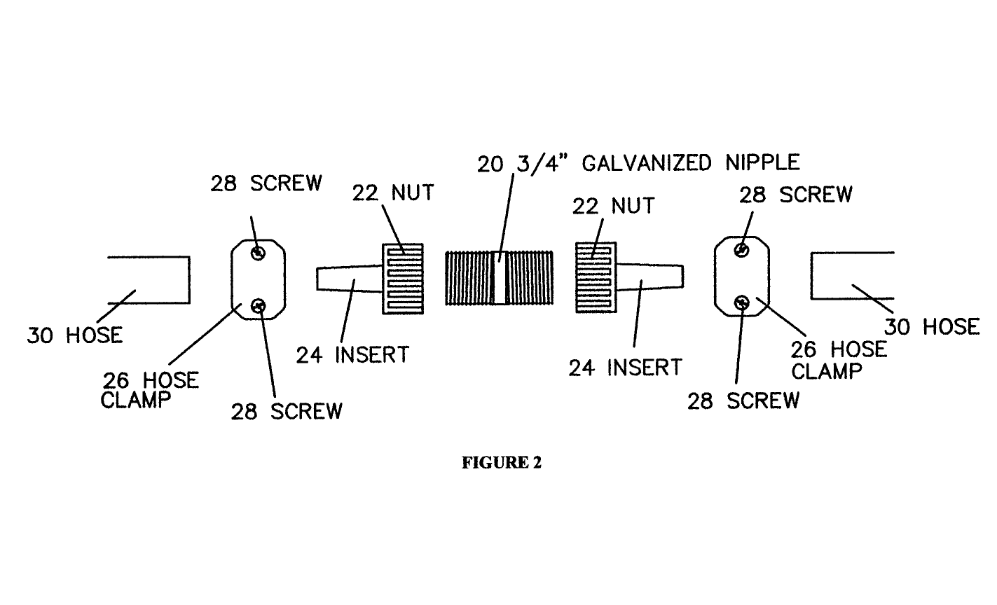

Assembly of the coupling device is illustrated in FIG. 2. A hose 30 is cut into two portions at a location determined by user preference. A nut 22 is positioned over each of the two inserts 24, so that each nut 22 rests against the lipped side of each insert 24. The first insert 24 is inserted into the first portion of the hose 30, while the second insert 24 is inserted into the second portion of the hose 30. The cut ends of the hose 30 fit snugly against each nut 22. The first hose clamp 26 is placed over the first insert 24 and first portion of the hose 30, while the second hose clamp 26 is placed over the second insert 24 and second portion of the hose 30. Screws 28 are tightened into each hose clamp 26. The threaded pipe nipple 20 is tightened against each insert 24 via each nut 22. However, the threaded pipe nipple 20 and each nut 22 are not completely tightened against one another; rather, said components are allowed to move relative to each other.

Alternative Embodiments

While the above description contains many specificities, these should not be construed as limitations on the scope of the invention, but rather as an exemplification of one preferred embodiment thereof Many variations are possible and some are as follows.

The hose clamp 26, nut 22, threaded pipe nipple 20, and insert 24 could be made of various materials, including metal, plastic, ceramic or composite materials. These materials allow differing strengths and weaknesses which would be used to match consumer preferences, needs, and budget restraints.

The hose clamp 26, nut 22, threaded pipe nipple 20, and insert 24 could be made in various sizes and shapes in order to fit the wide variety of hoses found in the market place. Moreover, variety of size and shape of these parts would allow increased flexibility to meet the needs of consumers.

Assembly of the hose coupling device could be implemented during manufacture of the hose instead of later assembly by the consumer. That is, the hose coupling device could be installed by the manufacturer. Thus, the consumer would not need to install the hose coupling device; rather, the device would be a feature of the hose allowing further incentive for purchase of the hose by the consumer.

Furthermore, securing the hose clamps may be done via various fastening devices. For instance, bolts, prickets, or pins or other similar fastening devices could be used.

The embodiments above-discussed are to be considered illustrative and not restrictive. Thus, the scope of the invention should be determined by the appended claims and their legal equivalents.

Conclusions, Ramifications, and Scope

The utility of the E-Z Hose is apparent. This invention provides the average, lay consumer with a solution to a common problem; namely, kinking of garden hoses. The implementation of this invention in a garden hose will not only eliminate torque, twisting, or kinking in the hose, it will alleviate user annoyance, frustration, and inefficiency associated with torque, twisting or kinking in a hose. The user of a hose equipped with this invention will no longer struggle with hose kinking and will be able to finish the task at hand in a time-efficient, relaxed manner. As the user of the hose moves from one watering location to another, the portions of the hose will freely rotate about the hose coupling device.

The above-discussion is to be considered illustrative and not restrictive. Thus, the scope of the invention should be determined by the appended claims and their legal equivalents.

I claim:

1. A hose coupling device comprising:
a. a first insert enabling attachment of said hose coupling device to a first hose,
b. a first nut engaging said first insert,
c. a first hose clamp securing said first hose to said first insert via screws,
d. a threaded pipe nipple engaging said first nut,
e. a second nut engaging said threaded pipe nipple,
f. a second insert engaging said second nut and enabling attachment of said hose coupling device to a second hose,
g. a second hose clamp securing said second hose to said second insert via screws, whereby said hoses and said hose coupling device will be joined; permitting rotation about a shared longitudinal axis; releasing torque, twisting or kinking.

2. The device of claim 1, wherein said nuts engage said inserts at lipped portions of said inserts.

3. The device of claim 1, wherein said hose clamps are secured to said inserts via bolts, prickets, or pins or other similar fastening device.

4. The device of claim 1, wherein said nuts engage said inserts at lipped portions of said inserts, and wherein said hose clamps are secured to said inserts via bolts, prickets, or pins, or other similar fastening device.

5. A method for releasing torque, twisting or kinking in a hose, comprising the steps of:
a. cutting a length a hose into two portions at a location likely to experience kinking,
b. introducing a first nut onto a first insert,
c. engaging a first hose clamp onto the first portion of said hose at said location,
d. engaging said first insert into said first portion of said hose at said location,
e. introducing a second nut onto a second insert,
f. engaging a second hose clamp onto the second portion of said hose at said location,
g. engaging said second insert into said second portion of said hose at said location,
h. connecting said first nut to said second nut via a threaded pipe nipple,
i. tightening screws into said hose clamps for securing said hose portions to said inserts,
whereby said two portions of said hose will rotate relative to each other, releasing torque, twisting or kinking in said hose.

6. The method of claim 5, wherein introducing said nuts against said inserts is accomplished at lipped portions of said inserts.

7. The method of claim 5, wherein securing said hose portions to said inserts, is accomplished via the tightening of bolts, prickets, or pins or other similar fastening device.

8. The method of claim 5, wherein introducing said nuts against said inserts is accomplished at lipped portions of said inserts, and wherein securing said hose portions to said inserts, is accomplished via the tightening of bolts, prickets, or pins or other similar fastening device.
